(19) United States
(12) Patent Application Publication
(10) Pub. No.: US 2017/0171621 A1
(43) Pub. Date: Jun. 15, 2017

(54) Method and Electronic Device for Information Processing

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Shaolong ZHU, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/241,930

(22) Filed: Aug. 19, 2016

Related U.S. Application Data
(63) Continuation of application No. PCT/CN2016/088478, filed on Jul. 4, 2016.

(30) Foreign Application Priority Data
Dec. 9, 2015 (CN) 201510908422.3

(51) Int. Cl. H04N 21/466; H04N 21/482; H04N 21/44; H04N 21/84; H04N 21/81; H04N 21/439

(52) U.S. Cl. CPC H04N 21/4667; H04N 21/8133; H04N 21/4394; H04N 21/44008; H04N 21/84; H04N 21/482

(57) ABSTRACT

The present disclosure discloses a method and an electronic device for information processing, and the method includes: extracting target feature information of a video when the video is played; acquiring content information that matches the target feature information from a pre-established feature database; generating a feature code according to the content information, and displaying the feature code on a video play display interface.

### CROSS-REFERENCE TO RELATED APPLICATION

The disclosure is a continuation of International Application No. PCT/CN2016/088478, with an international filing date of Jul. 4, 2016, which claims the benefit of Chinese Patent Application No. 201510908422.3 filed on Dec. 9, 2015, entitled “METHOD AND DEVICE FOR INFORMATION PROCESSING”, both of which are incorporated herein by reference in their entireties.

### TECHNICAL FIELD

The present disclosure relates to the field of information technique, and in particular, to a method and an electronic device for information processing.

### BACKGROUND

With the large-scale popularization of network and the increase in the types and numbers of media resources that may be selected and watched by users, many users have been accustomed to watch videos online via terminals (for example, a TV set and a computer, etc.). In order to acquire the feedback information on a video watched from a user so as to better satisfy different types of users on one hand, and to increase the degree of participation of a user when the user watches the video on the other hand, many media companies load a two-dimensional code containing specific information to a video, so that the degree of participation of a user may be increased and the feedback information on the video from the user may be acquired.

However, in the mode of loading two-dimensional code information to a video, it mainly depends on the generation of a two-dimensional code in advance; which cannot promote the enthusiasm of user participation, on the contrary, many users ignore the two-dimensional code appearing in the video or have a negative attitude on it. As a result, the two-dimensional code loaded to the video cannot play its expected role.

### SUMMARY

In order to overcome the problems in the prior art, the disclosure provides a method and an electronic device for information processing.

According to a first aspect of the embodiments of the disclosure, there provides a method for information processing, which includes:

Extracting target feature information of a video when the video is played;

Acquiring content information that matches the target feature information from a pre-established feature database; and

Generating a feature code according to the content information, and displaying the feature code on a video play display interface.

According to a second aspect of the embodiments of the present disclosure, the embodiment of the present disclosure provides a non-volatile computer-readable storage medium stored with computer executable instructions, the computer executable instructions perform any one of the method described above in the disclosure.

According to a third aspect of the embodiments of the present disclosure, the embodiment of the present disclosure provides an electronic device, including: at least one processor; and a memory; wherein, the memory is communicably connected with the at least one processor for storing instructions executed by the at least one processor, the computer executable instructions are configured to perform any one of the method described above in the disclosure.

### BRIEF DESCRIPTION OF THE DRAWINGS

One or more embodiments are illustrated by way of examples, and not by limitation, in the pictures of the accompanying drawings, wherein elements having the same reference numeral designations represent like elements throughout. The drawings are not to scale, unless otherwise disclosed.

FIG. 1 is a flow chart of a method for information processing according to an embodiment of the disclosure;

FIG. 2 is a flow chart of Step S110 in FIG. 1;

FIG. 3 is a flow chart of Step S120 in FIG. 1;

FIG. 4 is another flow chart of Step S110 in FIG. 1;

FIG. 5 is another flow chart of Step S120 in FIG. 1;

FIG. 6 is a schematic diagram of a device for information processing according to an embodiment of the disclosure;

FIG. 7 is a schematic diagram of a feature extraction unit in FIG. 6;

FIG. 8 is a schematic diagram of a content information acquisition unit in FIG. 6;

FIG. 9 is another schematic diagram of the feature extraction unit in FIG. 6;

FIG. 10 is another schematic diagram of the content information acquisition unit in FIG. 6; and

FIG. 11 is a structural schematic diagram of an electronic device provided by an embodiment of the disclosure.

### DETAILED DESCRIPTION

Exemplary embodiments, the examples of which are shown in the drawings, will be illustrated in detail here. When the description below is related to the drawings, the same number in different the drawings represents the same or similar element, unless otherwise expressed. The implementations described in the following embodiments do not represent all the implementation consistent with the disclosure. Instead, they are only examples of the device and the method consistent with some aspects of the disclosure as described in detail in the claims appended.

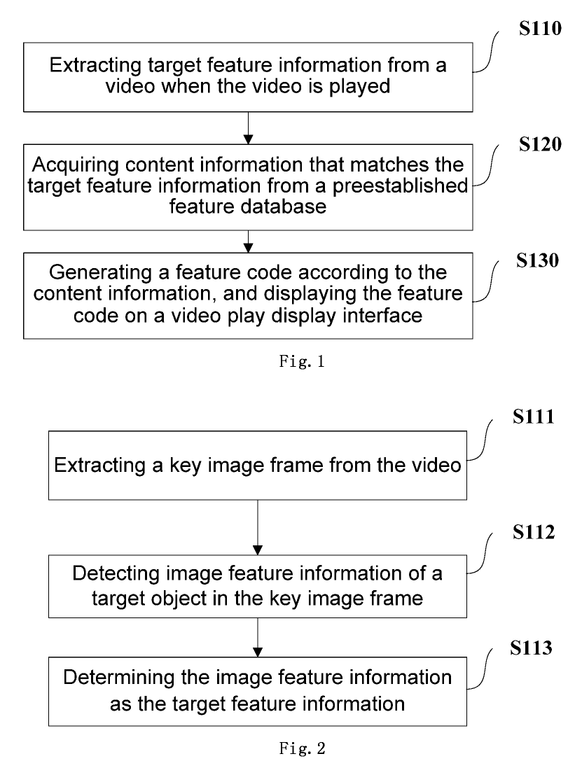

In order to solve the related problems, first of all, an embodiment of the disclosure provides a method for information processing, which is applied to a server; as shown in FIG. 1, the method may include the steps of:

In Step S110: target feature information is extracted from a video when the video is played.

When a video is played, in view of a user, the video may be classified as a prerecorded video or a live broadcast video. Prerecorded video refers to a video in a video database of a user download server, and it may be played after being downloaded, or, it may be watched online by a user via a terminal. For a media company, when a related two-dimensional code needs to be loaded to a video, based on a prerecorded video, the related two-dimensional code may be loaded to the video for being played by a user by processing the prerecorded video in advance. For a live broadcast video, because the media company cannot process such a video in advance, it needs to monitor the content of the video in real time and then generate a two-dimensional code and load it to the video.

In either of the above cases, it both needs to generate a two-dimensional code according to the video content in the video, which requires extracting the target feature information from the video, wherein the target feature information may include image feature information in the video or audio feature information in the video, or a combination of both. Exemplarily, when, in a video, a certain singer is singing a certain song, the data of the singer, for example, name, gender, constellation, hobby and birthday, etc., may be identified according to an image of the singer in the video; moreover, the song that the singer is singing may be identified by an audio feature in the song according to the song that the singer is singing in the video. At this point, a two-dimensional code may be generated according to the above data of the singer or the above data of the song or both and loaded to the video that is being played.

In step S120: content information that matches the target feature information is acquired from a pre-established feature database.

The feature database may be pre-established, in which content information corresponding to the target feature information in the video may be saved. Exemplarily, if a singer is singing a song in a video, the image feature of the singer and the audio feature of the song may be taken as the target feature information of the video, and data related to the singer and the song are saved in a pre-established feature database, thus it only needs to extract the target feature information in the video to acquire the content information corresponding to the target feature information.

In step S130: a feature code is generated according to the content information, and displayed on a video play display interface.

After the content information that matches the target feature information is acquired from the video, a corresponding feature code, for example, a two-dimensional code that is typically used at present, etc., may be generated from the content information. It should be noted that, when the corresponding two-dimensional code is generated according to the content information, if the amount of the content information is large such that all content information cannot be contained, a two-dimensional code may be generated according to a network address from which the content information is acquired. By scanning the two-dimensional code, a user may visit the network address obtained through an application such as a browser, etc., thereby the content information needed may be acquired. Additionally, the content information may also be other preset information, which may be a user survey, for example, an option feedback for a user to score the video, etc. The user may reply to the feedback information by scanning the two-dimensional code.

After the corresponding feature code is generated, it only needs to display the two-dimensional code at a certain location on the video display interface. For example, the two-dimensional code generated may be displayed at the bottom right corner of a player.

In the method for information processing according to the embodiment of the disclosure, when a video is played, content information that matches target feature information may be obtained from a feature database by extracting the target feature information from the video, and then a feature code is generated according to the content information and displayed at a certain preset location on a video play interface. Thus, when a user watches a video that is played, the user may scan the feature code on the video play interface via a terminal such as a mobile phone, etc. to acquire related content in the video conveniently, so that the user may acquire the information needed in time, additionally, the enthusiasm of the user for participating in video interaction may be promoted.

In order to describe in detail how target feature information is extracted from a video, as a detail of the method shown in FIG. 1, in another embodiment of the disclosure, as shown in FIG. 2, the Step S110 may further include:

In step S111: a key image frame is extracted from the video;

For an algorithm for extracting a key image frame from a video, an image frame containing a target object may be determined as a key image frame by processing the video, for example, detecting the texture feature and color feature of an image frame in the video. Additionally, during the determining of the key image frame, a similarity between other image frames to be processed and the key image frame determined may be calculated, and when the similarity is greater than a preset threshold, the image frame with a similarity greater than the preset threshold will be determined as the key image frame.

Exemplarily, an algorithm for extracting a key image frame from the video may be as follows: 1) extracting the color feature of an image frame from a video, and calculating the color distance between two adjacent image frames; 2) extracting the texture feature of an image in the video, and calculating the texture distance between two adjacent image frames; 3) obtaining a synthetic distance by performing a normalization process on the color distance and the texture distance between two adjacent image frames; 4) acquiring a preliminary key frame via distance accumulation according to a threshold that is set and the synthetic distance; and 5) acquiring a final key frame by performing mutation detection on the preliminary key frame selected.

In another example, Xiang He and Guanghui Lu put forward an algorithm for a key image frame in a video in Key Frame Extraction Algorithm Based On Image Similarity (Fujian Computer, No. 5, 2009), by which a key image frame may be well extracted from a video. There exist various mature algorithms for extracting a key image frame from the video, and no detailed description will be given here.

In step S112: the image feature information of the target object in the key image frame is detected.

In step S113: the image feature information is determined as the target feature information.

A video is consisted of a plurality of image frames that are played successively, and each image frame contains a specific picture. Among the image frames of a video, some image frames are important image frames that contain key contents, which are called key image frames here. Exemplarily, if, as the current content of a video, a singer is singing a song, an image frame containing a picture of the singer may be taken as a key image frame, and this key image frame may be extracted out.

As still illustrated by the example in which the current content of the video is that a singer is singing a song, after the key image frame containing the picture of the singer is extracted out, the image feature information of the target object in the key image frame is detected by using a related image identification algorithm. Exemplarily, after the key image frame is acquired, the personage feature in the key image frame is extracted via an algorithm such as a preprocessing algorithm and an image segmentation algorithm, etc., wherein the personage feature may be the feature information of the human face, and the name and other data of the singer may be acquired via a human face identification algorithm.

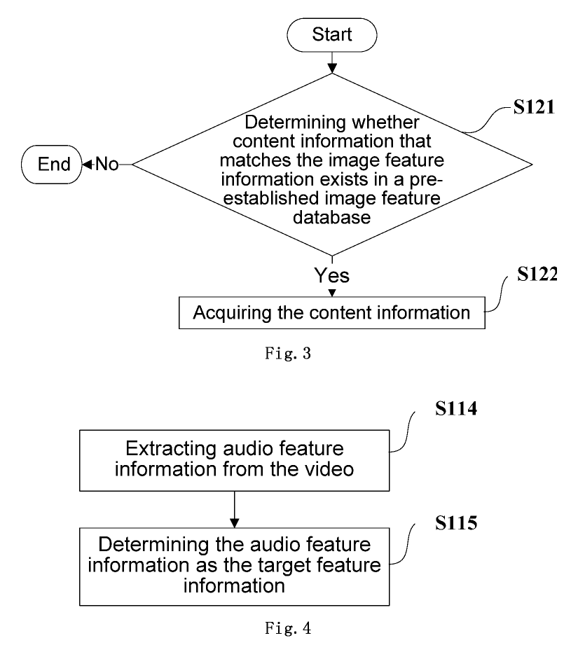

In order to obtain the content information that matches the target feature information, as a detail of the method shown in FIG. 1, in another embodiment of the disclosure, as shown in FIG. 3, Step S120 may further include:

In step S121: whether content information that matches the image feature information exists in a pre-established image feature database, is determined.

If the content information that matches the image feature information exists in the pre-established image feature database, the content information is acquired in Step S122.

When the target feature information is the image feature information of the target object, it needs to match the target feature information extracted from the video with a template feature in a pre-established image database, so as to identify the image feature; if it is identified successfully, the content information that matches the image feature will be acquired.

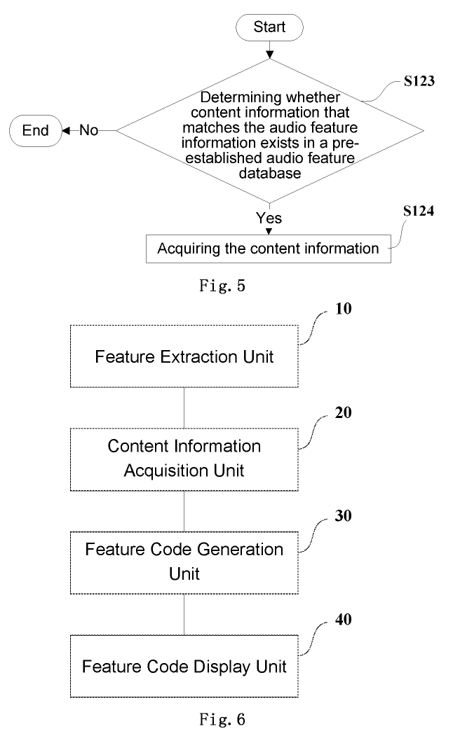

In order to further describe in detail how the target feature information is extracted from a video, as a detail of the method shown in FIG. 1, in another embodiment of the disclosure, as shown in FIG. 4, Step S110 may further include:

In step S114: an audio feature information is extracted from the video.

In step S115: the audio feature information is determined as the target feature information.

Because a video is generally consisted of video pictures and audio data, the audio feature information of the audio may be extracted from the video. Noise reduction, segmentation and feature extraction, etc., may be performed on audio data via an existing audio identification algorithm, which will not be described again here. The audio feature information extracted is taken as the target feature information of the video.

In order to obtain the content information that matches the target feature information, as a detail of the method shown in FIG. 1, in another embodiment of the disclosure, as shown in FIG. 5, the Step S120 may further include:

In step S123: whether content information that matches the audio feature information exists in a pre-established audio feature database, is determined;

If the content information that matches the audio feature information exists in the pre-established audio feature database, the content information is acquired in Step S124.

When the target feature information is audio feature information, it needs to match the audio feature information extracted from the video with a template feature in a pre-established audio database, so as to identify the audio feature; if it is identified successfully, the content information that matches the audio feature will be acquired.

Additionally, in one of the two modes according to the above embodiments, an image feature is extracted from the video, then content information that matches the image feature is acquired in a pre-established image feature database, and then a feature code is generated according to the content information and displayed on a video play interface; in the other of the two modes according to the above embodiments, an audio feature is extracted from the video, then content information that matches the audio feature is acquired in a pre-established audio feature database, and then a feature code is generated according to the content information and displayed on a video play interface. It should be noted that, in the embodiments of the disclosure, the above two modes may also be combined, and a feature code may be generated according to content information obtained by combining the content information that matches the image feature with the content information that matches the audio feature, and then displayed on a video play interface.

Exemplarily, if the current video content that is played in a video is that a singer is singing a song, the singer will be identified by extracting an image feature from the video, i.e., the image feature of the singer, thus the content information, for example, the name, gender, constellation, birthday and hobby, etc., of the singer, will be obtained; and the song will be identified by performing audio feature extraction on the song that the singer is singing, thus the content information, for example, the name, lyricist, composer and creation time, etc., of the song, will be obtained. Then, a feature code will be generated according to content information obtained by combining the above content information of the singer and the above information of the song, and finally, the feature code is displayed on a video play interface.

In the method for information processing according to the embodiment of the disclosure, when a video is played, by extracting target feature information from the video, content information that matches the target feature information may be obtained from a feature database, and then a feature code is generated according to the content information and displayed at a certain preset location on a video play interface. Thus, when a user watches a video that is played, the user may scan the feature code on the video play interface via a terminal such as a mobile phone, etc., to acquire the related content in the video conveniently, so that the user may acquire the information needed in time, and additionally, the enthusiasm of the user for participating in video interaction may be promoted.

Additionally, the content information that matches the image feature or the content information that matches the audio feature may be respectively obtained by extracting an image feature or an audio feature from the video respectively, and then a feature code may be generated according to the content information and displayed on a video play interface. Or, the content information that respectively matches the image feature and the audio feature extracted from the video may be combined, and a feature code may be generated according to the obtained content information and then displayed on a video play interface.

With the description of the above method embodiments, one skilled in the art may clearly understand that the disclosure may be implemented by the aid of software and necessary universal hardware platform, the disclosure may also be implemented by hardware of course; but in many cases, the former is preferred. Based on such an understanding, the essential part of the technical solutions in the embodiments of the disclosure, or in other words, the part that contributes to the prior art, may be embodied in the form of a software product, the software product is stored in a storage medium, for example, ROM, RAM, magnetic disc or compact disc, etc., and includes several instructions that can make a computer device (which may be a personal computer, a server or a network device, etc.) implement all or a part of the steps of the method according to each embodiment of the disclosure.

Additionally, for implementing each of the above embodiments, one embodiment of the disclosure further provides a device for information processing, which is located in a terminal; as shown in FIG. 6, the device includes: a feature extraction unit 10, a content information acquisition unit 20, a feature code generation unit 30 and a feature code display unit 40, wherein:

The feature extraction unit 10 extracts target feature information of a video when the video is played.

When a video is played, in view of a user, the video may be classified as a prerecorded video or a live broadcast video. Prerecorded video refers to a video in a video database on a user download server, and it may be played after being downloaded, or, it may be watched online by a user via a terminal. For a media company, when a related two-dimensional code needs to be loaded to a video, based on a prerecorded video, the related two-dimensional code may be loaded to the video for being played by a user by processing the these prerecorded video in advance. For a live broadcast video, because the media company cannot process such a video in advance, it needs to monitor the content of the video in real time and then generate a two-dimensional code and load it to the video.

In either of the above cases, it both needs to generate a two-dimensional code according to the video content in the video, which requires extracting the target feature information from the video, wherein the target feature information may include image feature information in the video or audio feature information in the video, or a combination of both. Exemplarily, when, a certain singer is singing a certain song in a video, the data of the singer, for example, name, gender, constellation, hobby and birthday, etc., may be identified according to an image of the singer in the video; moreover, the song that the singer is singing may be identified by an audio feature in the song according to the song that the singer is singing in the video. At this point, a two-dimensional code may be generated according to the above data of the singer or the above data of the song or both and loaded to the video that is being played.

The content information acquisition unit 20 acquires content information that matches the target feature information from a pre-established feature database.

The feature database may be pre-established, in which content information corresponding to the target feature information in the video may be saved. Exemplarily, if a singer is singing a song in a video, the image feature of the singer and the audio feature of the song may be taken as the target feature information of the video, and data related to the singer and the song are saved in a pre-established feature database, thus it only needs to extract the target feature information in the video to acquire the content information corresponding to the target feature information.

The feature code generation unit 30 generates a feature code according to the content information.

The feature code display unit 40 displays the feature code on a video play display interface.

After the content information that matches the target feature information is acquired from the video, a corresponding feature code, for example, a two-dimensional code that is typically used at present, etc., may be generated from the content information. It should be noted that, when the corresponding two-dimensional code is generated according to the content information, if the amount of the content information is large such that all content information cannot be contained, a two-dimensional code may be generated according to a network address from which the content information is acquired. By scanning the two-dimensional code, a user may visit the network address obtained through an application such as a browser, etc., thereby the content information needed may be acquired. Additionally, the content information may also be other preset information, which may be a user survey, for example, an option feedback for a user to score the video, etc. The user may reply to the feedback information by scanning the two-dimensional code.

After the corresponding feature code is generated, it only needs to display the two-dimensional code at a certain location on the video display interface. For example, the two-dimensional code generated may be displayed at the bottom right corner of a player.

In the device for information processing according to the embodiment of the disclosure, when a video is played, by extracting target feature information from the video, content information that matches the target feature information may be obtained from a feature database, and then a feature code is generated according to the content information and displayed at a certain preset location on a video play interface. Thus, when a user watches a video that is played, the user may scan the feature code on the video play interface via a terminal such as a mobile phone, etc., to acquire the related content in the video conveniently, so that the user may acquire the information needed in time, and additionally, the enthusiasm of the user for participating in video interaction may be promoted.

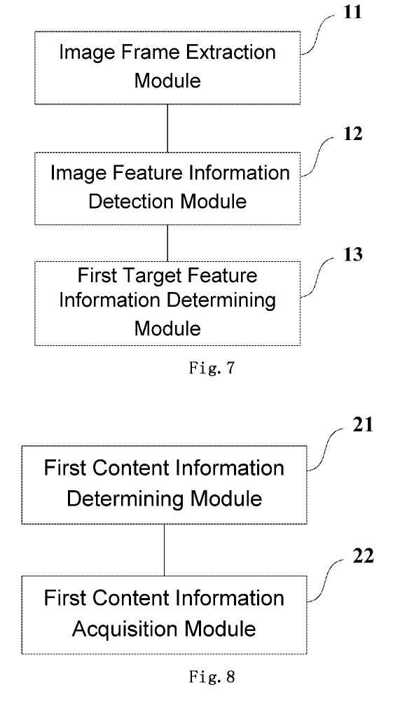

In another embodiment of the disclosure based on FIG. 6, as shown in FIG. 7, the feature extraction unit 10 includes: an image frame extraction module 11, an image feature information detection module 12 and a first target feature information determining module 13, wherein:

The image frame extraction module 11 extracts a key image frame from the video.

For an algorithm for extracting a key image frame from a video, reference may be made to the above introduction on the algorithm for extracting a key image frame from a video described above, which will not be described again here.

The image feature information detection module 12 detects image feature information of a target object in the key image frame.

The first target feature information determining module 13 determines the image feature information as the target feature information.

A video is consisted of a plurality of image frames that are played successively, and each image frame contains a specific picture. Among the image frames of a video, some image frames are important image frames that contain key contents, which are called key image frames here. Exemplarily, if, as the current content of a video, a singer is singing a song, an image frame containing a picture of the singer may be taken as a key image frame, and this key image frame may be extracted out.

As still illustrated by the example in which the current content of the video is that a singer is singing a song, after the key image frame containing the picture of the singer is extracted out, the image feature information of the target object in the key image frame is detected by using related image identification algorithm. Exemplarily, after acquiring the key image frame, the personage feature in the key image frame is extracted via a preprocessing algorithm and an image segmentation algorithm, etc., wherein the personage feature may be the feature information of the human face, and the name and other data of the singer may be acquired via a human face identification algorithm.

In another embodiment of the disclosure based on FIG. 6, as shown in FIG. 8, the target feature information includes the image feature information of the target object, and the content information acquisition unit 20 includes: a first content information determining module 21 and a first content information acquisition module 22.

The first content information determining module 21 determines whether content information that matches the image feature information exists in a pre-established image feature database.

The first content information acquisition module 22 acquires the content information when the content information that matches the image feature information exists in the pre-established image feature database.

When the target feature information is the image feature information of the target object, it needs to match the target feature information extracted from the video with a template feature in a pre-established image database, so as to identify the image feature; if it is identified successfully, the content information that matches the image feature will be acquired.

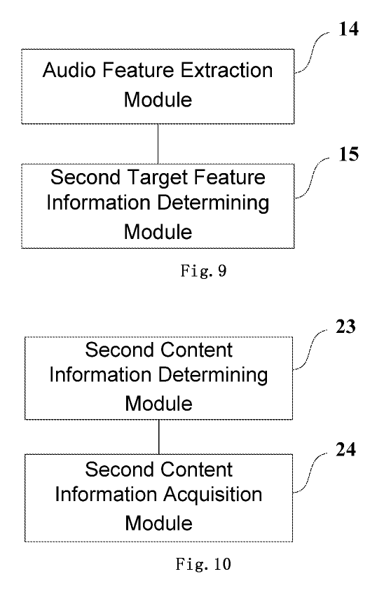

In another embodiment of the disclosure based on FIG. 6, as shown in FIG. 9, the feature extraction unit 10 includes: an audio feature extraction module 14 and a second target feature information determining module 15, wherein:

The audio feature extraction module 14 extracts audio feature information from the video.

The second target feature information determining module 15 determines the audio feature information as the target feature information.

Because a video is generally consisted of video pictures and audio data, the audio feature information of the audio may be extracted from the video. Noise reduction, segmentation and feature extraction, etc., may be performed on the audio data via an existing audio identification algorithm, which will not be described again here. The audio feature information extracted is taken as the target feature information of the video.

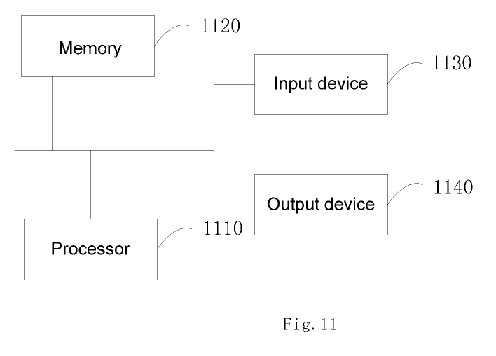

In another embodiment of the disclosure based on FIG. 6, as shown in FIG. 10, the feature information includes audio feature information, and the content information acquisition unit 20 includes: a second content information determining module 23 and a second content information acquisition module 24, wherein:

The second content information determining module 23 determines whether content information that matches the audio feature information exists in a pre-established audio feature database.

The second content information acquisition module 24 acquires the content information when the content information that matches the audio feature information exists in the pre-established audio feature database.

When the target feature information is audio feature information, it needs to match the audio feature information extracted from the video with a template feature in a pre-established audio database, so as to identify the audio feature; if it is identified successfully, the content information that matches the audio feature will be acquired.

In the device for information processing according to the embodiment of the disclosure, when a video is played, by extracting target feature information from the video, content information that matches the target feature information may be obtained from a feature database, and then a feature code is generated according to the content information and displayed at a certain preset location on a video play interface. Thus, when a user watches a video that is played, the user may scan the feature code on the video play interface via a terminal such as a mobile phone, etc. to acquire the related content in the video conveniently, so that the user may acquire the information needed in time, and additionally, the enthusiasm of the user for participating in video interaction may be promoted.

Additionally, the content information that matches an image feature or the content information that matches an audio feature may be respectively obtained by extracting the image feature or the audio feature from the video respectively, and then a feature code may be generated according to the content information and displayed on a video play interface. Or, the content information that respectively matches the image feature and the audio feature extracted from the video may be combined, and a feature code may be generated according to the obtained content information and then displayed on a video play interface.

An embodiment of the disclosure further provides a server, which includes the device for information processing according to any of the above embodiments.

An embodiment of the disclosure further provides a computer-readable storage medium stored with computer executable instructions, the computer executable instructions perform the method for information processing in any one of method embodiments described above.

FIG. 11 is a schematic diagram of hardware structure of an electronic device used to perform the method for information processing according to an embodiment of the present disclosure, as shown in FIG. 11, the device includes:

One or more processors 1110 and a memory 1120, FIG. 11 illustrates one processor 1110 as an example.

The device for information processing may further include an input device 1130 and an output device 1140.

The processor 1110, the memory 1120, the input device 1130 and the output device 1140 may be connected with each other through bus or other forms of connections. FIG. 11 illustrates bus connection as an example.

As a non-volatile computer-readable storage medium, the memory 1120 may store non-volatile software program, non-volatile computer executable program and modules, such as program instructions/modules corresponding to the method for information processing in the embodiments of the disclosure (for example, the feature extraction unit 10, the content information acquisition unit 20, the feature code generation unit 30 and the feature code display unit 40, as illustrated in FIG. 6). By executing the non-volatile software program, instructions and modules stored in the memory 1120, the processor 1110 may perform various functional applications of the server and data processing, that is, the method for information processing according to the above method embodiments.

The memory 1120 may include a program storage area and a data storage area, wherein, the program storage area may be stored with the operating system and applications which are needed by at least one functions, and the data storage area may be stored with data which is created according to use of the device described above. Further, the memory 1120 may include a high-speed random access memory, and may further include non-volatile memory, such as at least one of disk memory device, flash memory device or other types of non-volatile solid state memory device. In some embodiments, optionally, the memory 1120 may include memory provided remotely from the processor 1110, and such remote memory may be connected with the device described above through network connections, the examples of the network connections may include but not limited to internet, intranet, LAN (Local Area Network), mobile communication network or combinations thereof.

The input device 1130 may receive inputted number or character information, and generate key signal input related to the user settings and functional control of the device described above. The output device 1140 may include a display device such as a display screen.

The above one or more modules may be stored in the memory 1120, when these modules are executed by the one or more processors 1110, the method for information processing in above mentioned method embodiments may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) Mobile communication device, characterized in having a function of mobile communication mainly aimed at providing speech and data communication, wherein such terminal includes: smart phone (such as iPhone), multimedia phone, functional phone, low end phone and the like;

(2) Ultra mobile personal computer device, which falls in a scope of personal computer, has functions of calculation and processing, and generally has characteristics of mobile internet access, wherein such terminal includes: PDA, MID and UMPC devices, such as iPad;

(3) Portable entertainment device, which can display and play multimedia contents, and include audio or video player (such as iPad), portable game console , E-book and smart toys and portable vehicle navigation device;

(4) Server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) Other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of software product which can be stored in a computer-readable storage medium, such as ROM/RAM, magnetic disk and compact disc, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for information processing, comprising:
at an electronic device:
extracting target feature information of a video when the video is played;
acquiring content information that matches the target feature information from a pre-established feature database; and
generating a feature code according to the content information, and displaying the feature code in a video play display interface.

2. The method for information processing according to claim 1, wherein, the extracting target feature information of a video comprises:
extracting a key image frame from the video;
detecting image feature information of a target object in the key image frame; and
determining the image feature information as the target feature information.

3. The method for information processing according to claim 1, wherein, the target feature information comprises the image feature information of the target object;
the acquiring content information that matches the target feature information from a pre-established feature database comprises:
determining whether content information that matches the image feature information exists in a pre-established image feature database; and
acquiring the content information when the content information that matches the image feature information exists in the pre-established image feature database.

4. The method for information processing according to claim 1, wherein, the extracting target feature information of a video comprises:
extracting audio feature information from the video; and
determining the audio feature information as the target feature information.

5. The method for information processing according to claim 1, wherein, the feature information comprises audio feature information;
the acquiring content information that matches the target feature information from a pre-established feature database comprises:
determining whether content information that matches the audio feature information exists in a pre-established audio feature database; and
acquiring the content information when the content information that matches the audio feature information exists in the pre-established audio feature database.

6. A non-volatile computer-readable storage medium stored with computer executable instructions that, when executed by an electronic device, cause the electronic device to:
extract target feature information of a video when the video is played;
acquire content information that matches the target feature information from a pre-established feature database;
generate a feature code according to the content information, and display the feature code in a video play display interface.

7. The non-volatile computer-readable storage medium according to claim 6, wherein, extracting target feature information of a video comprises:
extracting a key image frame from the video;
detecting image feature information of a target object in the key image frame; and
determining the image feature information as the target feature information.

8. The non-volatile computer-readable storage medium according to claim 6, wherein, the target feature information comprises the image feature information of the target object;
the acquiring content information that matches the target feature information from a pre-established feature database comprises:
determining whether content information that matches the image feature information exists in a pre-established image feature database; and
acquiring the content information when the content information that matches the image feature information exists in the pre-established image feature database.

9. The non-volatile computer-readable storage medium according to claim 6, wherein, the extracting target feature information of a video comprises:
extracting audio feature information from the video; and
determining the audio feature information as the target feature information.

10. The non-volatile computer-readable storage medium according to claim 6, wherein, the feature information comprises audio feature information;
the acquiring content information that matches the target feature information from a pre-established feature database comprises:
determining whether content information that matches the audio feature information exists in a pre-established audio feature database; and
acquiring the content information when the content information that matches the audio feature information exists the pre-established audio feature database.

11. An electronic device, comprising:
at least one processor; and
a memory, communicably connected with the at least one processor; wherein, the memory is stored with instructions executed by the at least one processor, the execution of the instructions by the at least one processor causes the at least one processor to:
extract target feature information of a video when the video is played;
acquire content information that matches the target feature information from a pre-established feature database; and
generate a feature code according to the content information, and display the feature code in a video play display interface.

12. The electronic device according to claim 11, wherein, the extracting target feature information of a video comprises:
extracting a key image frame from the video;
detecting image feature information of a target object in the key image frame; and
determining the image feature information as the target feature information.

13. The electronic device according to claim 11, wherein, the target feature information comprises the image feature information of the target object;
the acquiring content information that matches the target feature information from a pre-established feature database comprises:
determining whether content information that matches the image feature information exists in a pre-established image feature database; and
acquiring the content information when the content information that matches the image feature information exists in the pre-established image feature database.

14. The electronic device according to claim 11, wherein, the extracting target feature information of a video comprises:
extracting audio feature information from the video; and
determining the audio feature information as the target feature information.

15. The electronic device according to claim 11, wherein, the feature information comprises audio feature information;
the acquiring content information that matches the target feature information from a pre-established feature database comprises:
determining whether content information that matches the audio feature information exists in a pre-established audio feature database; and
acquiring the content information when the content information that matches the audio feature information exists in the pre-established audio feature database.
